(19) United States
(12) Patent Application Publication
(10) Pub. No.: US 2008/0137830 A1
(43) Pub. Date: Jun. 12, 2008

(54) Dispatching A Message Request To A Service Provider In A Messaging Environment

(76) Inventors: Kulvir S. Bhogal, Fort Worth, TX (US); John J. Duigenan, New York, NY (US); Paul D. Lewis, Round Rock, TX (US); Ramanujam Ravisankar, Austin, TX (US); John J. Wang, Gaithersburg, MD (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/609,566

(22) Filed: Dec. 12, 2006

(51) Int. Cl. H04M 3/42

(52) U.S. Cl. 379/201.04

(57) ABSTRACT

Methods, apparatus, and products are disclosed for dispatching a message request to a service provider in a messaging environment that include: establishing, on a message administration device, a plurality of lookup tables for mapping request types to service providers; receiving, in the message administration device from a message requesting device, a message request of one of the request types; identifying, by the message administration device, the service provider for processing the message request in dependence upon the message request and the plurality of lookup tables; and providing, by the message administration device, the message request to the identified service provider.

### BACKGROUND OF THE INVENTION

1. Field of the Invention

The field of the invention is data processing, or, more specifically, methods, apparatus, and products for dispatching a message request to a service provider in a messaging environment.

2. Description Of Related Art

Messaging environments are generally available to provide data communication between message sending devices and message receiving devices using application messages. An application message is a quantity of data organized into one or more data fields and is passed from a message producer installed on a message sending device to a message consumer installed on a message receiving device. An application message is a form of message recognized by application software operating in the application layer of a data communication protocol stack-as contrasted for example with a transport message or network message which are forms of messages recognized in the transport layer and the network layer respectively. An application message may represent, for example, numeric or textual information, images, encrypted information, and computer program instructions. In a financial market data environment, an application message is commonly referred to as a ‘tick’ and includes financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security.

A messaging environment may support point-to-point messaging, publish and subscribe messaging, or both. In a point-to-point messaging environment, a message producer may address a message to a single message consumer. In a publish and subscribe messaging environment, a message producer may publish a message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

In either a point-to-point messaging environment or a publish and subscribe messaging environment, messaging receiving devices typically initiates a request to receive application messages from a message sending device. In a point-to-point messaging environment, the messaging receiving devices transmits such a message request directly to the message sending device. In a publish and subscribe messaging environment, the messaging receiving devices may transmit the message request to a message brokering device that manages the messages from multiple message sending devices. When the message sending device or the message brokering device receives a message request from a message sending device, the message sending device or the message brokering device typically looks up a service provider installed on the device capable of processing the particular message request received.

In current messaging environments, the message sending device and the message brokering device lookup the service provider for a message request using a single lookup table. The message sending device or the message brokering device looks up a service provider in such a lookup table using parameters of the message request. Typically, the values for request parameters serve as key values in the lookup table for identifying a particular service provider capable of processing the request. That is, using the values for the request parameters of the message request, the message sending device or the message brokering device may identify a particular service provider capable of processing the request. The number of records in the lookup table through which the message sending device or the message brokering device may have to traverse to identify a service provider depends on the number of request parameters in the message request and the number of possible values for each request parameter. Consider, for example, a message request with two request parameters—the first parameter has three possible values and the second parameter has two possible values. Using such a request, a messaging receiving device may specify up to six different types of application messages. A lookup table used to identify service providers capable of processing such an exemplary message request would typically include up to six records. In some scenarios, therefore, the message sending device or the message brokering device would have to traverse through six records before identifying the service provider capable of processing such an exemplary message request.

As the number of request parameters in a message request increases and the number of possible values for each request parameter increases, the number of records in the lookup table grows dramatically. Merely adding one request parameter having two possible values to a message request doubles the number of records in the lookup table needed to identify a service provider capable of processing the request. As the lookup table grows in size, the efficiency of identifying a service provider capable of processing a message request using a single table diminishes. Readers will therefore appreciate that room for improvement exists in dispatching message requests to service providers in message environments.

### SUMMARY OF THE INVENTION

Methods, apparatus, and products are disclosed for dispatching a message request to a service provider in a messaging environment that include: establishing, on a message administration device, a plurality of lookup tables for mapping request types to service providers, the service providers capable of processing message requests of each of the request types, the message requests of the request types specifying a plurality of request parameters, each request type specified by a parameter value for each request parameter, each lookup table corresponding to one of the request parameters, each lookup table including entries for parameter values of the request parameter corresponding to the lookup table, the entries included in the plurality of lookup tables corresponding to one of the request parameters specify the service providers, and the entries included in the plurality of lookup tables corresponding to the other request parameters specify logical connections among the plurality of lookup tables; receiving, in the message administration device from a message requesting device, a message request of one of the request types; identifying, by the message administration device, the service provider for processing the message request in dependence upon the message request and the plurality of lookup tables; and providing, by the message administration device, the message request to the identified service provider.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and block diagram illustrating an exemplary system for dispatching a message request to a service provider in a messaging environment according to exemplary embodiments of the present invention.

FIG. 2 sets forth a block diagram of automated computing machinery comprising an exemplary message administration device useful in dispatching a message request to a service provider in a messaging environment according to exemplary embodiments of the present invention.

FIG. 3 sets forth a flowchart illustrating an exemplary method of dispatching a message request to a service provider in a messaging environment according to exemplary embodiments of the present invention.

FIG. 4 sets forth a flowchart illustrating a further exemplary method of dispatching a message request to a service provider in a messaging environment according to exemplary embodiments of the present invention.

FIG. 5 sets forth a flowchart illustrating a further exemplary method of dispatching a message request to a service provider in a messaging environment according to exemplary embodiments of the present invention.

FIG. 6 sets forth a flowchart illustrating a further exemplary method of dispatching a message request to a service provider in a messaging environment according to exemplary embodiments of the present invention.

### DETAILED DESCRIPTION OF EXEMPLARY EMBODIMENTS

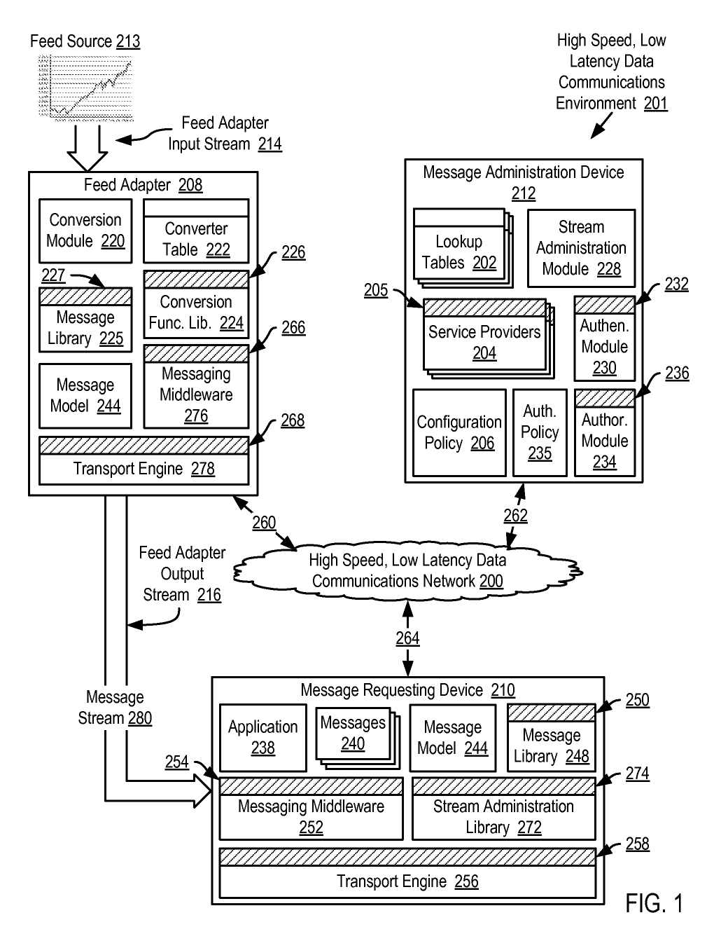

Exemplary methods, systems, and products for dispatching a message request to a service provider in a messaging environment according to embodiments of the present invention are described with reference to the accompanying drawings, beginning with FIG. 1. FIG. 1 sets forth a network and block diagram illustrating an exemplary system for dispatching a message request to a service provider in a messaging environment according to embodiments of the present invention. The system of FIG. 1 operates generally to dispatching a message request to a service provider in a messaging environment according to embodiments of the present invention as follows: The message administration device (212) establishes a plurality of lookup tables (202) for mapping a request type to a service provider (204). The message administration device (212) receives a message request of the request type from a message requesting device (210). The message administration device (212) identifies the service provider (204) for processing the message request in dependence upon the message request and the plurality of lookup tables (202) and provides the message request to the identified service provider (204).

The messaging environment illustrated in FIG. 1 is a high speed, low latency data communications environment (201) that includes a high speed, low latency data communications network (200). The network (200) includes a feed adapter (208), a message administration device (212), and a message requesting device (210), as well as the infrastructure for connecting such devices (208, 212, 210) together for data communications. The network (200) of FIG. 1 is termed ‘high speed, low latency’ because the application messages sent between devices connected to the network (200) on message streams administered by the message administration device (212) bypass the message administration device (212). For example, the application messages on the message stream (280) from the feed adapter (208) to the message requesting device (210) bypass the message administration device (212). Although such messages are not delayed for processing in the message administration device (212), the message administration device (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in dispatching a message request to a service provider in a messaging environment according to embodiments of the present invention may include a router.

The high speed, low latency data communications environment (201) depicted in FIG. 1 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’), or the Pragmatic General Multicast (‘PGM’) protocol. In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 1 includes a message administration device (212) connected to the high speed, low latency data communications network (200) through a wireline connection (262). The message administration device (212) of FIG. 1 is a computer device that receives message requests from a message requesting device and administers the transmission of application messages to the message requesting device. In the example of FIG. 1, the message administration device (212) has installed upon it a stream administration module (228), an authentication module (230), an authorization module (234), an authorization policy (235), service providers (204), a configuration policy (206), and a plurality of lookup tables (202).

The stream administration module (228) of FIG. 1 is a software component for administering the transmission of application messages to the message requesting device (210). The stream administration module (228) includes a set of computer program instructions for dispatching a message request to a service provider in a messaging environment according to embodiments of the present invention. The stream administration module (228) operates generally for dispatching a message request to a service provider in a messaging environment according to embodiments of the present invention by establishing a plurality of lookup tables (202) for mapping request types to service providers (202), receiving a message request of one of the request types from a message requesting device, identifying the service provider for processing the message request in dependence upon the message request and the plurality of lookup tables (202), and providing the message request to the identified service provider (204). Before dispatching a message request to a service processor, the message administration device (212) typically performs security services to ensure that the message requesting device only receives messages from the feed adapter for which the message requesting device is authorized to receive. The stream administration module (228) also operates generally for dispatching a message request to a service provider in a messaging environment according to embodiments of the present invention by determining whether the message requesting device is authorized to have the message request processed by the service provider (204), and providing the received message request to the identified service provider (204) if the message requesting device is authorized to have the message request processed by the service provider (204).

In the exemplary system of FIG. 1, the message request received from the message requesting device (210) is a request to establish a message stream (280) with a feed adapter (208). The stream administration module (228), therefore, also operates generally for dispatching a message request to a service provider in a messaging environment according to embodiments of the present invention by receiving, in response to providing the received message request to the identified service provider, a data communications endpoint of the message stream (280) from the feed adapter (208), and providing the data communications endpoint to the message requesting device (210). Using the data communications endpoint received from the message administration device, the message requesting device (210) may establish a message stream (280) with the feed adapter (208).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the message requesting device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the message requesting device (210) is authorized to receive on the message stream (280). The authorization module (234) of FIG. 1 provides authorization security services using an authorization policy (235). The authorization policy (235) is a set of rules governing the privileges of authenticated entities to have message requests processed by a service provider and the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

The service providers (204) of FIG. 1 are loadable software components that are capable of processing message requests of various request types. Different service providers (204) typically process different types of message requests; however, different service providers (204) may also process message requests of the same type. For example, one service provider may process message requests for application message containing real-time data, while another service provider processes message requests for application message containing historical data. In the example of FIG. 1, the service providers (204) may be implemented as dynamically linked libraries available to the stream administration module (228) at runtime, statically linked libraries linked into the stream administration module (228) at compile time, dynamically loaded Java classes, or any other implementation as will occur to those of skill in the art. The stream administration module (228) interacts with the service providers (204) through a set of APIs (205) exposed by the service providers (204).

The configuration policy (206) of FIG. 1 specifies the types of message requests that are processed by the service providers (204). The device uses the configuration policy (206) at startup to generate the plurality of lookup tables (202) utilized by the stream administration module (228) during runtime. The configuration policy (206) may be implemented using a structured document, such as, for example, an XML document, a Java object, C++ object, or any other implementation as will occur to those of skill in the art.

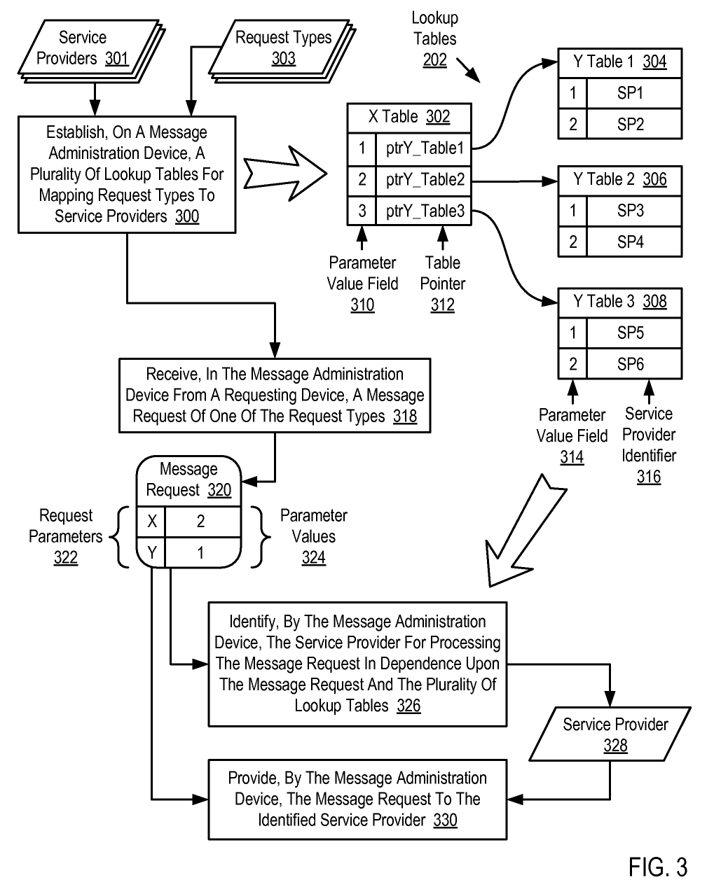

The plurality of lookup tables (202) of FIG. 1 is a set of two or more tables that together specify a mapping between request types and service providers. The message requests of the request types specify a plurality of request parameters. Each request type is specified by a parameter value for each request parameter. Each lookup table (202) corresponds to one of the request parameters and includes entries for parameter values of the request parameter corresponding to the lookup table (202). The entries included in the plurality of lookup tables (202) corresponding to one of the request parameters specify the service providers (204). The entries included in the plurality of lookup tables (202) corresponding to the other request parameters specify logical connections among the plurality of lookup tables (202). For further explanation, the plurality of lookup tables (202) is described in more detail with references to FIG. 3 below.

In the exemplary system of FIG. 1, feed adapter (208) is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to message requesting devices. The feed adapter input stream (214) is a message stream from a feed source to the feed adapter (208). The feed adapter output stream (216) is a message stream administered by the message administration device (212) from the feed adapter (208) to the message requesting device (210).

In the example of FIG. 1, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Centers™ which is an electronic screen-based equity securities market in the United States. In a financial market data environment, a feed adapter input stream is referred to as a ‘financial market data feed.’

The feed adapter (208) of FIG. 1 has installed upon it a conversion module (220), a converter table (222), conversion function library (224), a message library (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 1 is a data structure that specifies the converter functions capable of converting the application message from one format to another format. Utilizing multiple converter tables, the conversion module (220) may convert messages from a variety of input formats to a variety of output formats. In the example of FIG. 1, the converter table (222) specifies the converter functions capable of converting the application message received from the feed adapter input stream (214) having the first format to application messages (240) having the second format for transmission to message requesting devices on the feed adapter output stream (216). The converter table (222) of FIG. 1 may be implemented using a structured document such as, for example, an eXtensible Markup Language (‘XML’) document.

The conversion function library (224) of FIG. 1 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 1, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 1, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). That is, the message model (244) specifies a message format for interpreting application messages and includes one or more field specifications. Each field specification specifies a message field for storing data in an application message and includes field characteristics of the message field. In the example of FIG. 1, the message model (244) is established on both the feed adapter (208) and the message requesting device (210) by the message administration device (212) when the message administration device (212) brokers a message stream to a message requesting device. A message model may be implemented using a structured document, such as, for example, an XML document, a Java object, C++ object, or any other implementation as will occur to those of skill in the art.

In the example of FIG. 1, the conversion module (220) and the converter functions of the conversion function library (224) process the data contained in the application messages (240) using the message library (225). The message library (225) is a software module that includes a set of functions for creating, accessing, and manipulating messages (240) according to a message model (244). The message library (225) is accessible to the conversion module (220), the converter functions of the conversion function library (224), and the messaging middleware (276) through a message API (227) exposed by the message library (225).

Before the conversion module (220) of FIG. 1 performs data processing on the application messages, the conversion module (220) receives application messages (not shown) having a first format from the feed source (213). The conversion module (220) of FIG. 1 may receive the source stream messages through a receiving transport engine (not shown) of the feed adapter (208). The receiving transport engine is a software module that operates in the transport layer of the network stack and may be implemented according to the UDP/IP protocols, the PGM protocol, TCP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 1 performs data processing on the application messages received from the feed source (213), the conversion module (220) provides the application messages having the second format to the messaging middleware (276). The messaging middleware (276) of FIG. 1 is a software component that provides high availability services between the feed adapter (208), any backup feed adapter that may exist, the message requesting device (210), and the feed source (213). In addition, the messaging middleware (276) of FIG. 1 receives the converted application messages from the conversion module (220), augments the application message with administrative data, and provides the application messages to the transport engine (278) of the feed adapter (208) for transmission to the message requesting device (210). The conversion module (220) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, PGM protocol, or any other data communications protocols as will occur to those of skill in the art. The transport engine (278) is a software module that includes a set of computer program instructions for transmitting application messages to the message requesting device (210). The transport engine (278) of FIG. 1 may transmit the application messages (240) by receiving the application messages from the messaging middleware (276), encapsulating the application messages provided by the messaging middleware (276) into transport packets, and transmitting the packets through the message stream (280) to the message requesting device (210). The messaging middleware (276) operates the transport engine (278) through a transport API (268) exposed by the transport engine (278).

The message requesting device (210) in exemplary system of FIG. 1 connects to the high speed, low latency data communications network (200) through a wireline connection (264). The message requesting device (210) of FIG. 1 is a computer device capable of subscribing to the message streams transmitted by various feed adapters. In a financial market data environment, for example, a message requesting device may subscribe to a tick to receive the bid and ask prices for a particular security on a message stream provided by a feed adapter controlled by a financial securities broker.

In the example of FIG. 1, the message requesting device (210) has installed upon it an application (238), a message library (248), a message model (244), messaging middleware (252), a stream administration library (272), and a transport engine (256). The application (238) is a software component that processes data contained in the application messages (240) received from the feed adapter (208). The application (238) may process the data for utilization by the message requesting device (210) itself, for contributing the data to another feed adapter, or for contributing the data to some other device. In a financial market data environment, the application installed on the message requesting device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The message requesting device may then transmit the ticks to a feed adapter for resale to other message requesting devices.

The application (238) processes the data contained in the application messages (240) using the message library (248). The message library (248) is software module that includes a set of functions for creating, accessing, and manipulating messages (240) according to the message model (244) that is installed on both the feed adapter (208) and the message requesting device (210). The message library (248) is accessible to the application (238) through a message API (250) exposed by the message library (248).

The communications between the message requesting device (210) and the message administration device (212) may be implemented using a stream administration library (272). The stream administration library (272) is a set of functions contained in dynamically linked libraries or statically linked libraries available to the application (238) through a stream administration library API (274). Through the stream administration library (272), the message requesting device (210) of FIG. 1 may request to subscribe to messages from a feed adapter, modify an existing message subscription, or cancel a subscription. Functions of the stream administration library (272) used by the application (238) may communicate with the message administration device (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the message requesting device (210), the feed adapter (208), any backup feed adapters, and the stream administration module (212). In addition, the messaging middleware (252) performs message administration services for the application (238) and the stream administration library (272). The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, PGM protocol, or any other data communications protocols as will occur to those of skill in the art. The transport engine (256) is a software component for receiving application messages (240) from the feed adapter (208). The transport engine (256) receives the application messages (240) by receiving transport packets through the message stream (280) from the feed adapter (208), unencapsulating the application messages (240) from the received packets, and provides the application messages (240) to messaging middleware (252) of the message requesting device (210). In the example of FIG. 1, the messaging middleware (252) operates the transport engine (256) through a transport API (258) exposed by the transport engine (256).

The servers and other devices illustrated in the exemplary system of FIG. 1 are for explanation, not for limitation. Devices useful in dispatching a message request to a service provider in a messaging environment may be implemented using general-purpose computers, such as, for example, computer servers or workstations, hand-held held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 are for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

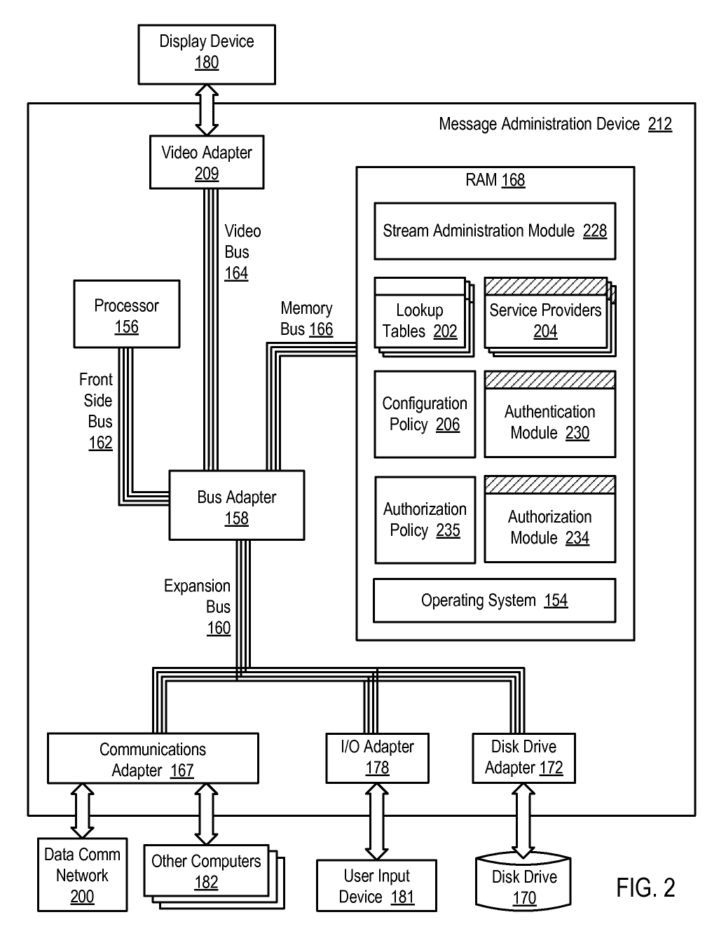

Dispatching a message request to a service provider in a messaging environment in accordance with the present invention in some embodiments may be implemented with one or more message administration devices, message requesting devices, and feed adapters. These devices and servers are, in turn, implemented to some extent at least as computers, that is, automated computing machinery. For further explanation, therefore, FIG. 2 sets forth a block diagram of automated computing machinery comprising an exemplary message administration device (212) useful in dispatching a message request to a service provider in a messaging environment according to embodiments of the present invention. The message administration device (212) of FIG. 2 includes at least one computer processor (156) or ‘CPU’ as well as random access memory (168) (‘RAM’) which is connected through a high speed memory bus (166) and bus adapter (158) to processor (156) and to other components of the message administration device.

Stored in RAM (168) is a stream administration module (228), an authentication module (230), an authorization module (234), an authorization policy (235), service providers (204), a configuration policy (206), and a plurality of lookup tables (202). The stream administration module (228), the authentication module (230), the authorization module (234), the authorization policy (235), the service providers (204), the configuration policy (206), and the plurality of lookup tables (202) illustrated in FIG. 2 are structured or operate as described above with reference to the message administration device of FIG. 1.

Also stored in RAM (168) is an operating system (154). Operating systems useful in message administration devices according to embodiments of the present invention include UNIX™, Linux™, Microsoft NT™, IBM's AIX™, IBM's i5/OS™, and others as will occur to those of skill in the art. The operating system (154), the stream administration module (228), the authentication module (230), the authorization module (234), the authorization policy (235), the service providers (204), the configuration policy (206), and the plurality of lookup tables (202) in the example of FIG. 2 are shown in RAM (168), but many components of such software typically are stored in non-volatile memory also, for example, on a disk drive (170).

The exemplary message administration device (212) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in message administration devices useful according to embodiments of the present invention include the Intel Northbridge, the Intel Memory Controller Hub, the Intel Southbridge, and the Intel I/O Controller Hub. Examples of expansion buses useful in message administration devices useful according to embodiments of the present invention may include Peripheral Component Interconnect (‘PCI’) buses and PCI Express (‘PCIe’) buses.

The exemplary message administration device (212) of FIG. 2 also includes disk drive adapter (172) coupled through expansion bus (160) and bus adapter (158) to processor (156) and other components of the exemplary message administration device (212). Disk drive adapter (172) connects non-volatile data storage to the exemplary message administration device (212) in the form of disk drive (170). Disk drive adapters useful in message administration devices include Integrated Drive Electronics (‘IDE’) adapters, Small Computer System Interface (‘SCSI’) adapters, and others as will occur to those of skill in the art. In addition, non-volatile computer memory may be implemented for a message administration device as an optical disk drive, electrically erasable programmable read-only memory (so-called ‘EEPROM’ or ‘Flash’ memory), RAM drives, and so on, as will occur to those of skill in the art.

The exemplary message administration device (212) of FIG. 2 includes one or more input/output (‘I/O’) adapters (178). I/O adapters in message administration devices implement user-oriented input/output through, for example, software drivers and computer hardware for controlling output to display devices such as computer display screens, as well as user input from user input devices (181) such as keyboards and mice. The exemplary message administration device (212) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary message administration device (212) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for dispatching a message request to a service provider in a messaging environment according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary message administration devices, readers will note that automated computing machinery used to implement exemplary message requesting devices and exemplary feed adapters useful in dispatching a message request to a service provider in a messaging environment according to embodiments of the present invention are similar to the exemplary message administration device (212) of FIG. 2. That is, such exemplary message requesting devices and feed adapters include one or more processors, bus adapters, buses, RAM, video adapters, communications adapters, I/O adapters, disk drive adapters, and other components similar to the exemplary message administration device (212) of FIG. 2 as will occur to those of skill in the art.

For further explanation, FIG. 3 sets forth a flowchart illustrating an exemplary method of dispatching a message request to a service provider in a messaging environment according to embodiments of the present invention. The method of FIG. 3 includes establishing (300), on a message administration device, a plurality of lookup tables (202) for mapping request types (303) to service providers (301). The message requests of request types (303) in the example of FIG. 3 specify a plurality of request parameters (322), and each request type (303) is specified by a parameter value for each request parameter. Each request type (303) of FIG. 3 represents a set of common characteristics for a group of message requests. That is, each message request of each request type (303) has the same set of characteristics as any other message request of the request type. The common characteristics among message requests of each request type (303) include the request parameters of message requests and the parameter values for each of the request parameters. Message requests of different request types, therefore, have different parameter values for the request parameters.

Consider, for example, message requests of two different request types-the first request type representing message requests for application messages containing real-time data, and the second request type that representing message requests for application messages containing historical data. In such an example, the message requests of both request types have two request parameters-a request parameter ‘X’ and a request parameter ‘Y.’ Message requests of the first request type may specify values ‘1’ and ‘1 ’ for the request parameter ‘X’ and the request parameter ‘Y,’ respectively. Message requests of the second request type may specify values ‘1’ and ‘2’ for the request parameter ‘X’ and the request parameter ‘Y,’ respectively. Readers will note that these examples are for explanation only and not for limitation. Other request types as will occur to those of skill in the art may also be useful in dispatching a message request to a service provider in a messaging environment according to embodiments of the present invention.

In the example of FIG. 3, the plurality of lookup tables (202) is a set of two or more tables that together specify a mapping between a request type and a particular service provider. The plurality of lookup tables (202) illustrated in FIG. 3 consists of four lookup tables (302, 304, 306, 308). Each lookup table (302, 304, 306, 308) corresponds to one of the request parameters of a message request of one of the request types (303). Continuing with the example from above, consider that the message requests for each of the request types (303) of FIG. 3 include two request parameters-a request parameter ‘X’ and a request parameter ‘Y.’ The lookup table (302) of FIG. 3 corresponds with the request parameter ‘X,’ and each lookup table (304, 306, 308) corresponds with the request parameter ‘Y.’

In the example of FIG. 3, each lookup table (302, 304, 306, 308) includes an entry for the parameter values of the request parameter corresponding to the lookup table. Continuing with the example from above, consider that the request parameter ‘X’ has three possible parameter values—‘1,’ ‘2,’ and ‘3’—and the request parameter ‘Y’ has two possible parameter values—‘1,’ and ‘2.’ In the example of FIG. 3, therefore, the lookup table (302) includes three entries, one entry for each possible parameter value of ‘1,’ ‘2,’ or ‘3’ for the request parameter ‘X.’ Similarly, each lookup table (304, 306, 308) includes two entries, one entry for each possible parameter value of ‘1’ or ‘2’ for the request parameter ‘Y.’ Readers will appreciate that one parameter value for each request parameters may be implemented as a default value. That is, each lookup table may also include an entry containing a default value for the request parameter corresponding to the lookup table.

In the example of FIG. 3, each entry included in the lookup tables (304, 306, 308) of the plurality of lookup tables (202) specifies one of the service providers (301). As mentioned above, the service provider is a software component capable of processing message requests of a request type. To specify one of the service providers (301), each entry of each lookup table (304, 306, 308) includes a parameter value field (314) and a service provider identifier (316). In the example of FIG. 3, the parameter value field (314) represents a data field for storing one of the possible parameter values for the request parameter ‘Y’ corresponding to each lookup table (304, 306, 308). The service provider identifier (316) represents a data field for storing an identifier for one of the service providers (301). For further explanation, consider the exemplary lookup table (308) illustrated in FIG. 3. A value of ‘1’ for the request parameter ‘Y’ of a message request specifies a service provider identified by a value of ‘SP5’ for the service provider identifier (316). A value of ‘2’ for the request parameter ‘Y’ of a message request specifies a service provider identified by a value of ‘SP6’ for the service provider identifier (316).

Readers will note that three different lookup tables (304, 306, 308) in the example of FIG. 3 correspond to the request parameter ‘Y.’ In the example of FIG. 3, the lookup table (304, 306, 308) corresponding to the request parameter ‘Y’ that is utilized to identify a service provider depends on the parameter value for the request parameter ‘X’ of a message request. A mapping between the parameter values of the request parameter ‘X’ and the lookup tables (304, 306, 308) corresponding to the request parameter ‘Y’ is contained in the other lookup table (302). The entries included in the lookup table (302) corresponding to the request parameter ‘X’ specify logical connections among the plurality of lookup tables (201). A logical connection is typically implemented as a pointer to a computer memory address at which another lookup table is stored. To specify a logical connection, each entry of the lookup table (302) includes a parameter value field (310) and a table pointer (312). The parameter value field (310) represents a data field for storing one of the possible parameter values for the request parameter corresponding to the lookup table (302). The table pointer (312) represents a data field for storing a pointer to another lookup table. For further explanation, consider the exemplary lookup table (302) of FIG. 3. A value of ‘1’ for the request parameter ‘X’ of a message request specifies a pointer ‘ptrY_Table1’ to the lookup table (304). A value of ‘2’ for the request parameter ‘X’ of a message request specifies a pointer ‘ptrY_Table2’ to the lookup table (306). A value of ‘3’ for the request parameter ‘X’ of a message request specifies a pointer ‘ptrY_Table3’ to the lookup table (308). Depending on the parameter value for the request parameter ‘X’ in the example of FIG. 3, the message administration device selects different lookup tables to identify the service provider using the value for the request parameter ‘Y.’

The method of FIG. 3 includes receiving (318), in the message administration device from a message requesting device, a message request (320) of one of the request types (303). The message request (320) of FIG. 3 represents a request for application message from the message administration device itself or from a feed adapter. The message request (320) of FIG. 3 may be implemented as an XML document, a call to a member method of a RMI object on the message requesting device, or any other implementation as will occur to those of skill in the art. The message administration device may receive (318) the message request (320) through an administrative data communications connection implemented using UDP/IP, TCP/IP, or any other data communications protocols as will occur to those of skill in the art.

In the example of FIG. 3, the message request (320) specifies a plurality of request parameters (322), and each request parameter (322) has a parameter value (324). The request type of the message request (320) is identified by the parameter values (324) for each of the request parameters (322). Continuing with the example from above, the request parameter ‘X’ of the message request (320) has a value of ‘2,’ and the request parameter ‘Y’ of the message request (320) has a value of ‘1.’ The request type of the message request (320), therefore, is specified using the parameter values ‘2’ and ‘1’ for the request parameter ‘X’ and the request parameter ‘Y,’ respectively.

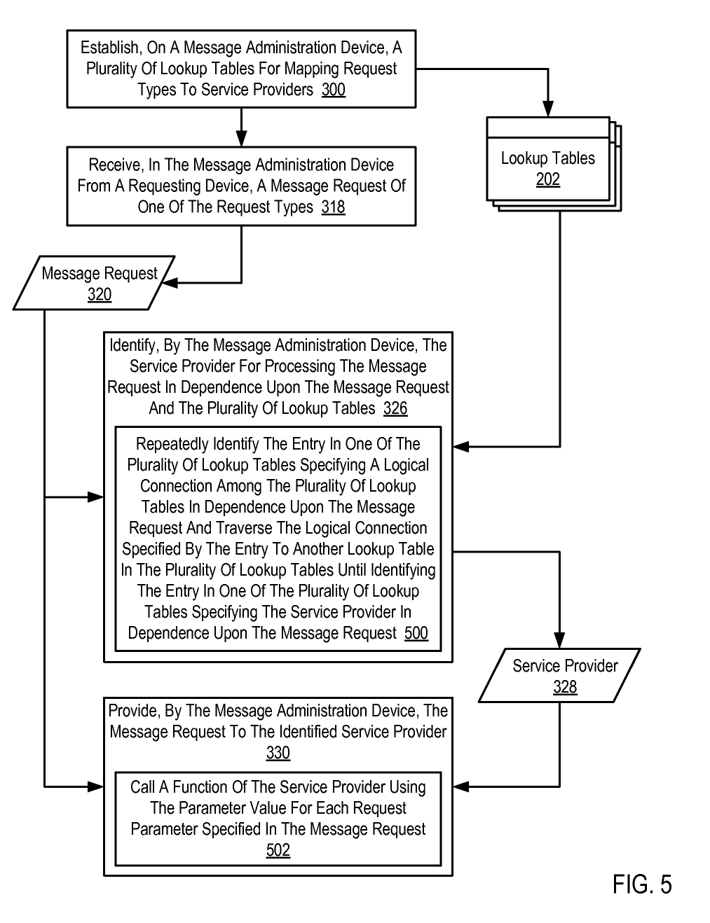

The method of FIG. 3 also includes identifying (326), by the message administration device, the service provider (328) for processing the message request (320) in dependence upon the message request (320) and the plurality of lookup tables (202). The message administration device may identify (326) the service provider (328) according to the method of FIG. 3 by repeatedly identifying the entry in one of the plurality of lookup tables specifying a logical connection among the plurality of lookup tables in dependence upon the message request (320) and traversing the logical connection specified by the entry to another lookup table in the plurality of lookup tables until identifying the entry in one of the plurality of lookup tables specifying the service provider in dependence upon the message request (320) as discussed below with reference to FIG. 5.

The method of FIG. 3 includes providing (330), by the message administration device, the message request (320) to the identified service provider (328). The message administration device may provide (330) the message request (320) to the identified service provider (328) by calling a function of the service provider (328) using the parameter value for each request parameter specified in the message request (320) as discussed below with reference to FIG. 5.

Readers will note from the exemplary set of lookup tables (202) illustrated in FIG. 3 that the maximum number of records traversed to identify a service provider for any message request is five records. That is, the message administration device may traverse three records in the lookup table (302), follow the pointer ‘ptrY_Table3’ to the lookup table (308), and traverse two records in the lookup table (308). To represent the same information that is represented in the plurality of lookup tables (202) in a single table would require six records. The maximum number of records traversed to identify a service provider using a single table, therefore, is six records. The difference in the number of maximum record traversals between methods using a single table and dispatching a message request to a service provider according to embodiments of the present invention is one record. This difference in the number of maximum row traversals between methods using a single table and dispatching a message request to a service provider according to embodiments of the present invention grows rapidly as the number of request parameters and request values increases in a messaging environment. The plurality of lookup tables (202), therefore, provides an efficient way of dispatching message requests to a service provider in a messaging environment.

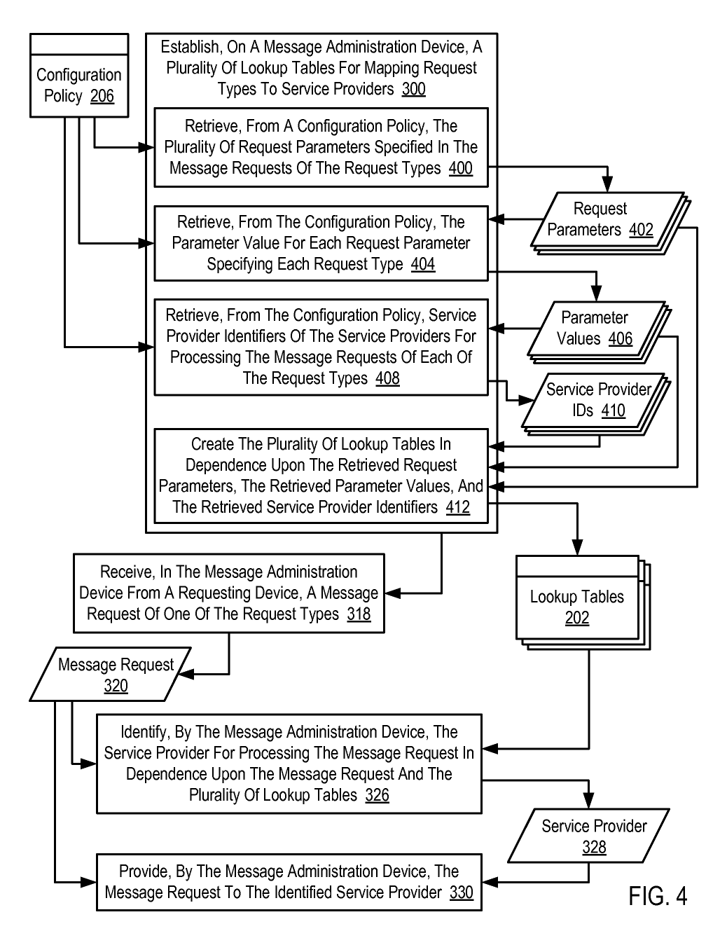

A message administration device may establish a plurality of lookup tables for mapping request types to service providers by creating the plurality of lookup tables in dependence upon request parameters, parameter values, and service provider identifiers retrieved from a configuration policy. For further explanation, FIG. 4 sets forth a flowchart illustrating a further exemplary method of dispatching a message request to a service provider in a messaging environment according to embodiments of the present invention that includes creating (412) the plurality of lookup tables (202) in dependence upon a retrieved request parameters (402), a retrieved parameter values (406), and a retrieved service provider identifier (410). The method of FIG. 4 is similar to the method of FIG. 3. That is, the method of

FIG. 4 includes establishing (300), on a message administration device, a plurality of lookup tables (202) for mapping request types to service providers capable of processing message requests of each of the request types; receiving (318), in the message administration device from a message requesting device, a message request (320) of one of the request types; identifying (326), by the message administration device, the service provider (328) for processing the message request (320) in dependence upon the message request (320) and the plurality of lookup tables (202); and providing (330), by the message administration device, the message request (320) to the identified service provider (328). The example of FIG. 4 is also similar to the example of FIG. 3 in that the message requests of the request types specify a plurality of request parameters, and each request type is specified by a parameter value for each request parameter.

In the method of FIG. 4, establishing (300), on a message administration device, a plurality of lookup tables (202) includes retrieving (400), from a configuration policy (206), the plurality of request parameters (402) specified in the message requests of the request types, retrieving (404), from the configuration policy (206), the parameter value for each request parameter specifying each request type, and retrieving (408), from the configuration policy (206), service provider identifiers (410) of the service providers for processing the message requests of each of the request types. The configuration policy (206) of FIG. 4 specifies the types of message requests that are processed by each service providers (204) available to the message administration device. The message administration device uses the configuration policy (206) at startup to generate the plurality of lookup tables (202) that are used by the message administration device to perform lookups during normal operation at runtime. The configuration policy (206) may be implemented using a structured document, such as, for example, an XML document, a Java object, C++ object, or any other implementation as will occur to those of skill in the art.

Establishing (300), on a message administration device, a plurality of lookup tables (202) according to the method of FIG. 4 also includes creating (412) the plurality of lookup tables (202) in dependence upon the retrieved request parameters (402), the retrieved parameter values (406), and the retrieved service provider identifiers (410). The message administration device may create (412) the plurality of lookup tables (202) according to the method of FIG. 4 by generating a lookup table for the first request parameter and inserting entries into the lookup table for each of the possible parameter values for the first request parameter. Consider for example, that the configuration policy specifies that message requests for each request type have two request parameters-a first request parameter ‘X’ and a second request parameter ‘Y.’ Further consider that the first request parameter ‘X’ has three possible values ‘1,’ ‘2,’ and ‘3.’ The message administration device may generate a lookup table for the request parameter ‘X’ that includes three entries, one entry for each value.

The message administration device may further create (412) the plurality of lookup tables (202) according to the method of FIG. 4 by generating lookup tables for the second request parameter, and inserting entries into each lookup table for each of the possible parameter values for the second request parameter. The number of lookup tables generated for the second request parameter matches the number of entries in the lookup table for the first request parameter. The message administration device may then insert pointers to each of the lookup tables for the second request parameter into the entries of the lookup table for the first request parameter. Continuing with the example from above, consider that the second request parameter ‘Y’ has two possible values ‘1’ and ‘2.’ The message administration device may generate three lookup table for the request parameter ‘Y’ because the lookup table for the request parameter ‘X’ has three entries. The message administration device may then insert a pointer for one of lookup tables corresponding to request parameter ‘Y’ into each entry of the lookup table for the request parameter ‘X.’ The message administration device may insert two entries into each lookup table corresponding to a request parameter ‘Y’ for the two possible parameter values of the request parameter ‘Y.’

The message administration device may continue to create (412) the plurality of lookup tables (202) according to the method of FIG. 4 by repeating generating a set of lookup table for each of the request parameters (402) until a set of lookup tables has been generated for each request parameter (402). Typically, the number of lookup tables for each request parameter (402) grows with each subsequent set of lookup tables generates. For example, when a first request parameter has three possible values, the message administration device generates one lookup table with three entries. If a second request parameter exists, then the message administration device generates three lookup tables for the second request parameter because the first parameter has three possible values and corresponds to only one table. Because of the logical connections among the lookup tables, each of the three lookup tables for the second request parameter also corresponds to one possible value for the first request parameter. If the second request parameter has two possible values, then each of the three lookup tables for the second request parameter has two entries-one for each possible value of the second request parameter. If a third request parameter exists, then the message administration device generates six lookup tables for the third request parameter because the second parameter has two possible values and three lookup tables exist for the second request parameter. Because of the logical connections among the lookup tables, each of the six lookup tables for the second request parameter also corresponds to one possible combination of values for the first request parameter and the second request parameter. If the third request parameter has three possible values, then each of the six lookup tables for the third request parameter has three entries-one for each possible value of the third request parameter.

The message administration device may further create (412) the plurality of lookup tables (202) according to the method of FIG. 4 by inserting a received service provider identifier (410) into each of the entries in each of the lookup tables corresponding to the last request parameter (406) specified in the configuration policy. Readers will recall that each lookup table corresponding to the last request parameter (406) also corresponds to one possible combination of values for the other request parameters (406), and each entry in each lookup table for the last request parameter (406) corresponds to one of the possible parameter values of the last request parameter (406). Each entry in each lookup table corresponding to the last request parameter (406), therefore, specifies a service provider for a unique combination of values for all of the request parameters (406).

After establishing the plurality of lookup tables (202) on a message administration device as discussed above, the plurality of lookup tables (202) is available for use by the message administration device to identify a service provider for processing a message request according to embodiments of the present invention. Each lookup table (202) corresponds to one of the request parameters. Each lookup table (202) includes entries for parameter values of the request parameter corresponding to the lookup table (202). The entries included in the plurality of lookup tables (202) corresponding to one of the request parameters specify the service providers. The entries included in the plurality of lookup tables (202) corresponding to the other request parameters specify logical connections among the plurality of lookup tables (202).

As mentioned above, the message administration device may identify the service provider by repeatedly identifying the entry in one of the plurality of lookup tables specifying a logical connection among the plurality of lookup tables in dependence upon the message request and traversing the logical connection specified by the entry to another lookup table in the plurality of lookup tables until identifying the entry in one of the plurality of lookup tables specifying the service provider in dependence upon the message request. For further explanation, FIG. 5 sets forth a flowchart illustrating a further exemplary method of dispatching a message request to a service provider in a messaging environment according to embodiments of the present invention that includes repeatedly (500) identifying the entry in one of the plurality of lookup tables (202) specifying a logical connection among the plurality of lookup tables (202) in dependence upon the message request (320) and traversing the logical connection specified by the entry to another lookup table in the plurality of lookup tables (202) until identifying the entry in one of the plurality of lookup tables (202) specifying the service provider in dependence upon the message request (320).

The method of FIG. 5 is similar to the method of FIG. 3. That is, the method of FIG. 5 includes establishing (300), on a message administration device, a plurality of lookup tables (202) for mapping request types to service providers capable of processing message requests of each of the request types; receiving (318), in the message administration device from a message requesting device, a message request (320) of one of the request types; identifying (326), by the message administration device, the service provider (328) for processing the message request (320) in dependence upon the message request (320) and the plurality of lookup tables (202); and providing (330), by the message administration device, the message request (320) to the identified service provider (328). The example of FIG. 5 is also similar to the example of FIG. 3 in that the message requests of the request types specify a plurality of request parameters, and each request type is specified by a parameter value for each request parameter. Each lookup table (202) corresponds to one of the request parameters. Each lookup table (202) includes entries for parameter values of the request parameter corresponding to the lookup table (202). The entries included in the plurality of lookup tables (202) corresponding to one of the request parameters specify the service providers. The entries included in the plurality of lookup tables (202) corresponding to the other request parameters specify logical connections among the plurality of lookup tables (202).

In the method of FIG. 5, identifying (326), by the message administration device, the service provider (328) for processing the message request (320) in dependence upon the message request (320) and the plurality of lookup tables (202) includes repeatedly (500) identifying the entry in one of the plurality of lookup tables specifying a logical connection among the plurality of lookup tables in dependence upon the message request (320) and traversing the logical connection specified by the entry to another lookup table in the plurality of lookup tables until identifying the entry in one of the plurality of lookup tables specifying the service provider in dependence upon the message request (320). The message administration device may identify and traverse the logical connection specified by an entry in one of the lookup tables according to the method of FIG. 5 by comparing the parameter value for the first request parameter in the message request (320) to the parameter values stored in the entries of the lookup table (202) corresponding to the first parameter request and following the pointer to the next lookup table (202) that is associated with the entry having a parameter value that matches the parameter value for the message request (320). If no parameter value in the lookup table corresponding to the first request parameter matches the parameter value for the message request, then the message administration may follow the pointer that is associated with a default value. This process of comparing parameter values included in the entries of the lookup table with the parameter value for the message request and following the pointer to the next lookup table is repeated until the reaching a lookup table associated with the last request parameter. The entry that includes a parameter value matching the parameter value for the message request (320) includes an identifier for the service provider (328) capable of processing the message request (320).

In the method of FIG. 5, providing (330), by the message administration device, the message request (320) to the identified service provider (328) includes calling (502) a function of the service provider using the parameter value for each request parameter specified in the message request (320). The function of the service provider may be function contained in a dynamically linked library installed on the message administration server, a member method of a Java RMI object or a CORBA object, or any other implementation as will occur to those of skill in the art. For example, consider the following exemplary function of a service provider useful in dispatching a message request to a service provider in a messaging environment according to embodiments of the present invention:

endpoint * SP.process_message_request(int parameter1, int parameter 2, string parameter3).

The exemplary function ‘process_message_request’ instructs the service provider to process the message request received by the message administration device using the parameters ‘parameter1,’ ‘parameter2,’ and ‘parameter3.’ The value provided by the stream administration device for each parameter ‘parameter1,’ ‘parameter2,’ and ‘parameters’ may be the values for the request parameters specified by the message request (320). The exemplary function ‘process message request’ returns a pointer to a computer memory address where a data structure representing a data communication endpoint exists. The message administration device may then provide such a data communication endpoint to the message requesting device for listening for application messages provided in response to the request. Readers will note that the exemplary function described above is for explanation and not for limitation. In fact, other exemplary functions as will occur to those of skill in the art may also be useful in dispatching a message request to a service provider in a messaging environment according to embodiments of the present invention.

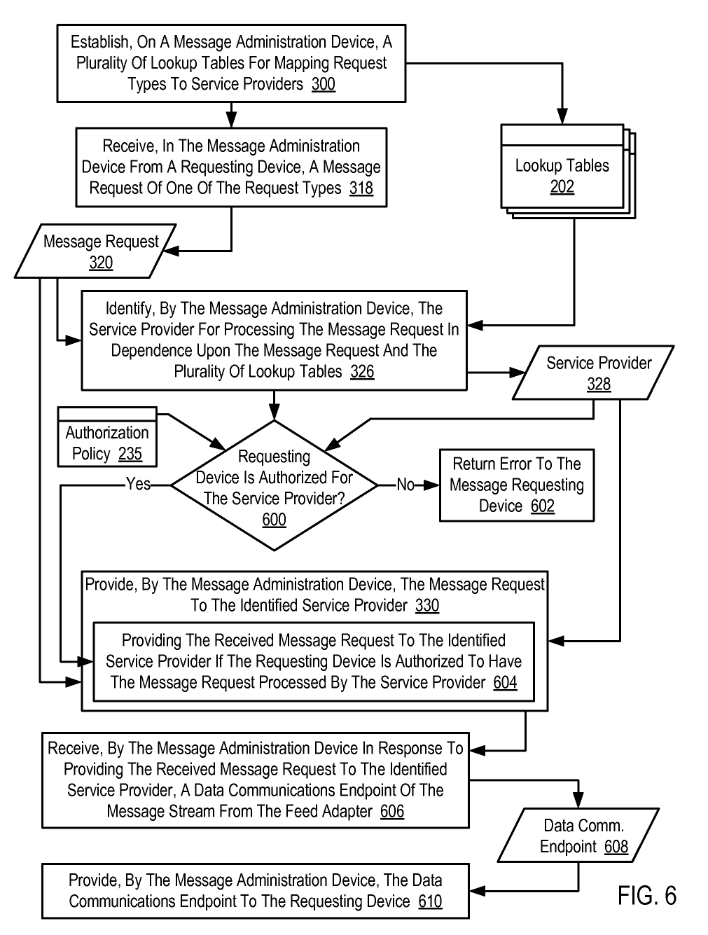

As mentioned above, a message request may be implemented as a request to establish a message stream with a feed adapter. In response to receiving a message request, the message administration device may provide a data communications endpoint of a message stream from a feed adapter to the message requesting device. For further explanation, FIG. 6 sets forth a flowchart illustrating a further exemplary method of dispatching a message request to a service provider in a messaging environment according to embodiments of the present invention that includes providing (610), by the message administration device, the data communications endpoint (608) to the message requesting device.

The method of FIG. 6 is similar to the method of FIG. 3. That is, the method of FIG. 6 includes establishing (300), on a message administration device, a plurality of lookup tables (202) for mapping request types to service providers capable of processing message requests of each of the request types; receiving (318), in the message administration device from a message requesting device, a message request (320) of one of the request types; identifying (326), by the message administration device, the service provider (328) for processing the message request (320) in dependence upon the message request (320) and the plurality of lookup tables (202); and providing (330), by the message administration device, the message request (320) to the identified service provider (328). The example of FIG. 6 is also similar to the example of FIG. 3 in that the message requests of the request types specify a plurality of request parameters, and each request type is specified by a parameter value for each request parameter. Each lookup table (202) corresponds to one of the request parameters. Each lookup table (202) includes entries for parameter values of the request parameter corresponding to the lookup table (202). The entries included in the plurality of lookup tables (202) corresponding to one of the request parameters specify the service providers. The entries included in the plurality of lookup tables (202) corresponding to the other request parameters specify logical connections among the plurality of lookup tables (202).

Readers will note that not all message requesting devices may be authorized to have message requests processed by service provider. The method of FIG. 6, therefore, includes determining (600) whether the message requesting device is authorized to have the message request processed by the service provider (328). The message administration device may determine (600) whether the message requesting device is authorized to have the message request processed according to the method of FIG. 6 by authenticating the message requesting device and identifying whether the privilege to utilize the identified service provider (328) is associated with the authenticated message requesting device in an authorization policy (235). The authorization policy (235) is a set of rules governing the privileges of authenticated message requesting devices to have message requests processed by a service provider. If the privilege to utilize the identified service provider (328) is associated with the authenticated message requesting device in the authorization policy (235), then the message requesting device is authorized to have the message request processed. If the privilege to utilize the identified service provider (328) is not associated with the authenticated message requesting device in the authorization policy (235), then the message requesting device is not authorized to have the message request processed.

The message administration device may authenticate a message sending device by verifying the security credentials provided by the message requesting device with the message request (320). The client security credentials may be implemented as a digital signature in a public key infrastructure, a security token, or any other security data as will occur to those of skill in the art for authenticating the identity of the originator of the message request (320). Examples of security token may include those security tokens described in the web services specification entitled ‘Web Services Security’ (‘WS-Security’) developed by IBM, Microsoft, and VeriSign or the web services specification entitled ‘Web Services Trust Language’ (‘WS-Trust’) developed by IBM, Microsoft, VeriSign, OpenNetworks, Layer 7, Computer Associates, BEA, Oblix, Reactivity, RSA Security, Ping Identity, and Actional.

The method of FIG. 6 includes returning (602) an error to the message requesting device if the message requesting device is not authorized to have the message request processed by the service provider (328). The error may include a code representing that the message requesting device is not authorized to have the message request processed by the service provider (328). The error may be implemented as an XML document, a return value from a method of a RMI or CORBA object called from the message requesting device.

In the method of FIG. 6, providing (330), by the message administration device, the message request (320) to the identified service provider (328) includes providing (604), by the message administration device, the received message request (320) to the identified service provider (328) if the message requesting device is authorized to have the message request processed by the service provider (328). The message requesting device may provide (604) the received message request (320) to the identified service provider (328) according to the method of FIG. 6 by calling a function of the service provider using the parameter value for each request parameter specified in the message request as mentioned above.

Readers will recall that the message request (320) in the example of FIG. 6 is implemented as a request to establish a message stream with a feed adapter. The method of FIG. 6, therefore, includes receiving (606), by the message administration device in response to providing the received message request to the identified service provider, a data communications endpoint (608) of the message stream from the feed adapter. The data communications endpoint (608) represents a data structure that includes a network address at which the message request device may listen for application messages from the feed adapter. The data communications endpoint (406) of FIG. 4 may be implemented according to the UDP/IP protocols, the PGM protocol, or any other data communications protocols as will occur to those of skill in the art. The message administration device may receive (606) the data communications endpoint (608) according to the method of FIG. 6 as a return value from a service provider function called by the message administration device.

The method of FIG. 6 also includes providing (610), by the message administration device, the data communications endpoint (608) to the message requesting device. The message administration device may provide (610) the data communications endpoint (608) to the message requesting device according to the method of FIG. 6 by transmitting the data communications endpoint (608) to the message requesting device as a return value from a method of a RMI or CORBA object called from the message requesting device.

In view of the explanations set forth above in this document, readers will recognize that dispatching a message request to a service provider in a messaging environment according to embodiments of the present invention provides the following benefits:
a reduction in the maximum number of records traversed to identify a service provider for processing a message request from current dispatching systems, and
an ability to efficiently specify default request parameters for dispatching message requests to service providers.

Exemplary embodiments of the present invention are described largely in the context of a fully functional computer system for dispatching a message request to a service provider in a messaging environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of dispatching a message request to a service provider in a messaging environment, the method comprising:
establishing, on a message administration device, a plurality of lookup tables for mapping request types to service providers, the service providers capable of processing message requests of each of the request types, the message requests of the request types specifying a plurality of request parameters, each request type specified by a parameter value for each request parameter, each lookup table corresponding to one of the request parameters, each lookup table including entries for parameter values of the request parameter corresponding to the lookup table, the entries included in the plurality of lookup tables corresponding to one of the request parameters specify the service providers, and the entries included in the plurality of lookup tables corresponding to the other request parameters specify logical connections among the plurality of lookup tables;
receiving, in the message administration device from a message requesting device, a message request of one of the request types;
identifying, by the message administration device, the service provider for processing the message request in dependence upon the message request and the plurality of lookup tables; and
providing, by the message administration device, the message request to the identified service provider.

2. The method of claim 1 wherein establishing, on a message administration device, a plurality of lookup tables for mapping a request type to a service provider further comprises:
retrieving, from a configuration policy, the plurality of request parameters specified in the message requests of the request types;
retrieving, from the configuration policy, the parameter value for each request parameter specifying each request type;
retrieving, from the configuration policy, service provider identifiers of the service providers for processing the message requests of each of the request types; and
creating the plurality of lookup tables in dependence upon the retrieved request parameters, the retrieved parameter values, and the retrieved service provider identifiers.

3. The method of claim 1 wherein identifying, by the message administration device, the service provider for processing the message request in dependence upon the message request and the plurality of lookup tables further comprises repeatedly identifying the entry in one of the plurality of lookup tables specifying a logical connection among the plurality of lookup tables in dependence upon the message request and traversing the logical connection specified by the entry to another lookup table in the plurality of lookup tables until identifying the entry in one of the plurality of lookup tables specifying the service provider in dependence upon the message request.

4. The method of claim 1 wherein providing, by the message administration device, the received message request to the identified service provider further comprises calling a function of the service provider using the parameter value for each request parameter specified in the message request.

5. The method of claim 1 further comprising:
determining whether the message requesting device is authorized to have the message request processed by the service provider,
wherein providing, by the message administration device, the received message request to the identified service provider further comprises providing, by the message administration device, the received message request to the identified service provider if the message requesting device is authorized to have the message request processed by the service provider.

6. The method of claim 1 wherein the message request is a request to establish a message stream with a feed adapter, the method further comprising:
receiving, by the message administration device in response to providing the received message request to the identified service provider, a data communications endpoint of the message stream from the feed adapter; and
providing, by the message administration device, the data communications endpoint to the message requesting device.

7. The method of claim 1 wherein the parameter value for at least one of the request parameters is a default value.

8. The method of claim 1 wherein the messaging environment is a financial market data messaging environment.

9. An apparatus for dispatching a message request to a service provider in a messaging environment, the apparatus comprising a computer processor, a computer memory operatively coupled to the computer processor, the computer memory having disposed within it computer program instructions capable of:
establishing, on a message administration device, a plurality of lookup tables for mapping request types to service providers, the service providers capable of processing message requests of each of the request types, the message requests of the request types specifying a plurality of request parameters, each request type specified by a parameter value for each request parameter, each lookup table corresponding to one of the request parameters, each lookup table including entries for parameter values of the request parameter corresponding to the lookup table, the entries included in the plurality of lookup tables corresponding to one of the request parameters specify the service providers, and the entries included in the plurality of lookup tables corresponding to the other request parameters specify logical connections among the plurality of lookup tables;
receiving, in the message administration device from a message requesting device, a message request of one of the request types;
identifying, by the message administration device, the service provider for processing the message request in dependence upon the message request and the plurality of lookup tables; and
providing, by the message administration device, the message request to the identified service provider.

10. The apparatus of claim 9 wherein establishing, on a message administration device, a plurality of lookup tables for mapping a request type to a service provider further comprises:
retrieving, from a configuration policy, the plurality of request parameters specified in the message requests of the request types;
retrieving, from the configuration policy, the parameter value for each request parameter specifying each request type;
retrieving, from the configuration policy, service provider identifiers of the service providers for processing the message requests of each of the request types; and
creating the plurality of lookup tables in dependence upon the retrieved request parameters, the retrieved parameter values, and the retrieved service provider identifiers.

11. The apparatus of claim 9 further comprising computer program instructions capable of:
determining whether the message requesting device is authorized to have the message request processed by the service provider,
wherein providing, by the message administration device, the received message request to the identified service provider further comprises providing, by the message administration device, the received message request to the identified service provider if the message requesting device is authorized to have the message request processed by the service provider.

12. The apparatus of claim 9 wherein the message request is a request to establish a message stream with a feed adapter, the apparatus further comprising computer program instructions capable of:
receiving, by the message administration device in response to providing the received message request to the identified service provider, a data communications endpoint of the message stream from the feed adapter; and
providing, by the message administration device, the data communications endpoint to the message requesting device.

13. A computer program product for dispatching a message request to a service provider in a messaging environment, the computer program product disposed upon a recordable medium, the computer program product comprising computer program instructions capable of:
establishing, on a message administration device, a plurality of lookup tables for mapping request types to service providers, the service providers capable of processing message requests of each of the request types, the message requests of the request types specifying a plurality of request parameters, each request type specified by a parameter value for each request parameter, each lookup table corresponding to one of the request parameters, each lookup table including entries for parameter values of the request parameter corresponding to the lookup table, the entries included in the plurality of lookup tables corresponding to one of the request parameters specify the service providers, and the entries included in the plurality of lookup tables corresponding to the other request parameters specify logical connections among the plurality of lookup tables;
receiving, in the message administration device from a message requesting device, a message request of one of the request types;
identifying, by the message administration device, the service provider for processing the message request in dependence upon the message request and the plurality of lookup tables; and
providing, by the message administration device, the message request to the identified service provider.

14. The computer program product of claim 13 wherein establishing, on a message administration device, a plurality of lookup tables for mapping a request type to a service provider further comprises:
retrieving, from a configuration policy, the plurality of request parameters specified in the message requests of the request types;
retrieving, from the configuration policy, the parameter value for each request parameter specifying each request type;
retrieving, from the configuration policy, service provider identifiers of the service providers for processing the message requests of each of the request types; and
creating the plurality of lookup tables in dependence upon the retrieved request parameters, the retrieved parameter values, and the retrieved service provider identifiers.

15. The computer program product of claim 13 wherein identifying, by the message administration device, the service provider for processing the message request in dependence upon the message request and the plurality of lookup tables further comprises repeatedly identifying the entry in one of the plurality of lookup tables specifying a logical connection among the plurality of lookup tables in dependence upon the message request and traversing the logical connection specified by the entry to another lookup table in the plurality of lookup tables until identifying the entry in one of the plurality of lookup tables specifying the service provider in dependence upon the message request.

16. The computer program product of claim 13 wherein providing, by the message administration device, the received message request to the identified service provider further comprises calling a function of the service provider using the parameter value for each request parameter specified in the message request.

17. The computer program product of claim 13 further comprising computer program instructions capable of:
determining whether the message requesting device is authorized to have the message request processed by the service provider,
wherein providing, by the message administration device, the received message request to the identified service provider further comprises providing, by the message administration device, the received message request to the identified service provider if the message requesting device is authorized to have the message request processed by the service provider.

18. The computer program product of claim 13 wherein the message request is a request to establish a message stream with a feed adapter, the apparatus further comprising computer program instructions capable of:
receiving, by the message administration device in response to providing the received message request to the identified service provider, a data communications endpoint of the message stream from the feed adapter; and
providing, by the message administration device, the data communications endpoint to the message requesting device.

19. The computer program product of claim 13 wherein the parameter value for at least one of the request parameters is a default value.

20. The computer program product of claim 13 wherein the messaging environment is a financial market data messaging environment
